(19) United States
(12) Patent Application Publication
(10) Pub. No.: US 2008/0234402 A1
(43) Pub. Date: Sep. 25, 2008

(54) Polyisocyanurate Rigid Foam and Method for the Production Thereof

(75) Inventors: Pit Lehmann, Osnabruck (DE); Peter von Malotki, Schwepnitz (DE); Gianpaolo Tomasi, Diepholz (DE); Gillian Peden, Alfreton (GB); Rainer Hensiek, Melle (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/065,359

(22) PCT Filed: Aug. 21, 2006
(86) PCT No.: PCT/EP2006/065487

§ 371 Date: Feb. 29, 2008

(30) Foreign Application Priority Data
Sep. 1, 2005 (DE) 102005041763.9

(51) Int. Cl. C08J 9/00

(52) U.S. Cl. 521/118

(57) ABSTRACT

The invention relates to a catalyst system, in particular for rigid polyisocyanurate foams blown by means of formic acid, a process for producing them and the rigid polyisocyanurate foams which can be obtained by such a process.

The invention relates to a catalyst system comprising
i) at least one compound having the structure:

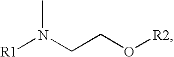

where R¹ is CH₃, CH₂—CH₂—N(CH₃)₂ or CH₂—CH₂OH and
R² is H, CH₂—CH₂OH or CH₂—CH₂N(CH₃)₂,
and
ii) at least one trimerization catalyst.

Furthermore, the present invention relates to the use of this catalyst system for producing rigid polyisocyanurate foams blown by means of formic acid and a process for producing rigid polyisocyanurate foams blown by means of formic acid and comprising the catalyst system. Further embodiments of the present invention are indicated in the claims, the description and the examples. It goes without saying that the abovementioned features and the features still to be explained below of the subject matter of the invention can be employed not only in the combination indicated in each case but also in other combinations without going outside the scope of the invention.

Polyisocyanurate foams, in particular rigid polyisocyanurate foams, have been known for a long time and have been described widely in the literature. They are usually produced by reacting polyisocyanates with compounds having hydrogen atoms which are reactive toward isocyanate groups, usually polyetherols, polyesterols or both, with the isocyanate index being 180 or above. This results in formation of not only the urethane structures which are formed by reaction of isocyanates with compounds having reactive hydrogen atoms but also, due to reaction of the isocyanate groups with one another, isocyanurate structures or further structures formed by reaction of isocyanate groups with other groups, for example polyurethane groups.

In general, both blowing and gelling catalysts, usually amines, and trimerization catalysts are used as catalysts in the production of rigid polyisocyanurate foams.

Catalyst systems comprising a mixture of various catalysts are also found in the prior art.

These rigid polyisocyanurate foams are usually produced using physical and chemical blowing agents. For the purposes of the present invention, chemical blowing agents are compounds which form gaseous products by reaction with isocyanate. Physical blowing agents are compounds which are dissolved or emulsified in the starting materials for polyurethane production and vaporize under the conditions of polyurethane formation. Possible chemical blowing agents are in particular water and also carboxylic acids. Physical blowing agents used are, for example, chlorofluorocarbons, hydrofluorocarbons, hydrocarbons and liquid CO₂.

JP 2002338651 describes the use of water as chemical blowing agent and a catalyst system comprising, inter alia, the salt of a carboxylic acid having from 3 to 20 carbon atoms and a quaternary ammonium salt for producing a polyurethane foam. In the examples given here, pentamethyldiethylenetriamine (PMDETA) and dimethylcyclohexylamine (DMCHA) are used as additional catalysts.

The use of carboxylic acids, primarily formic acid, as chemical blowing agents for preparing polyurethane foams has likewise been known for a long time.

U.S. Pat. No. 5,143,945 describes the production of a polyisocyanurate foam using a trimerization catalyst and the blowing agents water and formic acid.

U.S. Pat. No. 5,214,076 describes the production of an open-celled carbodiimideisocyanurate foam from aromatic polyesterols and aromatic amine polyetherols in the presence of a blowing agent which may comprise formic acid and a blowing catalyst, for example pentamethyldiethylenetriamine.

On the other hand, U.S. Pat. Nos. 5,478,494 and 5,770,635 describe specific polyol compositions for producing rigid polyisocyanurate foams for batchwise production of sandwich elements using formic acid as blowing agent and a delayed blowing catalyst, for example bis(2-(N,N-dimethylamino)ethyl)ether, which is blocked with, for example, acetic acid and a delayed gel catalyst comprising alicyclic or aliphatic, tertiary amines. The action of the catalysts is delayed by blocking with carboxylic acids.

EP 1435366 describes the use of a novolak polyetherol for producing rigid polyisocyanurate and polyurethane-modified polyisocyanurate foams blown by means of formic acid in both batch and continuous processes. Here, it is possible to use one or more catalysts, for example amine catalysts such as pentamethyldiethylenetriamine and tin catalysts such as tin salts of carboxylic acids.

Rigid isocyanurate foams are preferably produced by a continuous process, for example by the double belt process. The use of water as chemical blowing agent in the production of rigid polyisocyanurate foams is subject to restrictions, since a considerable amount of isocyanate is consumed in the reaction with isocyanate to generate the blowing gas.

If the good burning properties characteristic of rigid isocyanurate foams are to be achieved, isocyanate indices of >300 are necessary. In addition, it is desirable to work at the customary mixing ratios of polyol:isocyanate of from 100:110 to 100:230 owing to the existing machine technology and to ensure optimal mixing of the isocyanate and the polyol component. Even at mixing ratios of polyol:isocyanate=100:230, it is no longer possible to achieve the desired isocyanate index of >300 above an amount of water of one part by weight or more, based on the polyol component. For this reason, only a small proportion of water and in addition a physical blowing agent, usually hydrocarbons, for example pentane, is usually used in large amounts in the prior art in order to obtain the desired amount of blowing gas. This in turn has negative effects on the flame-retardant properties of the rigid polyisocyanurate foam. The use of chlorofluorocarbons and hydrofluorocarbons is often not a good alternative from an environmental point of view and because of the usually very high price.

In the processes known from the prior art, formic acid as blowing agent has the disadvantage that the rigid polyisocyanurate foams blown with formic acid cure only slowly. In a batch process, this leads to very long mold times and thus to poor economics and in a continuous process it leads to very slow belt speeds which are difficult to manage from an engineering point of view.

Rigid polyisocyanurate foams are used, in particular, for thermal insulation, for example of refrigeration appliances, containers or buildings, in the latter specifically as insulation boards or metal-isocyanurate-metal sandwich elements. For building products, the European Commission has developed a standard burning test, the “single burning item” test (SBI test) in accordance with EN 13823, which takes into account not only the spread of the fire in the material but also smoke evolution. Furthermore, insurance companies have recently introduced additional fire tests which in some instances go distinctly beyond the statutory requirements. The loss prevention standard LPS 1181 is an example.

A general problem with such rigid polyisocyanurate foams is also the formation of surface defects, preferably at the interface to metallic covering layers. These are usually gas inclusions between foam and metal sheet. These foam surface defects result, especially under the action of heat, in formation of an uneven metal surface. Such surface defects can, for example, be caused by the additives comprised in the surface coatings on the rear side of the covering layers, e.g. flow improvers, deaeration agents or hydrophobicizing agents. Since sandwich elements are used predominantly for the insulation of buildings, they not only have the purpose of providing insulation but also form the exterior of these buildings to a significant extent. Unevennesses in the metal surface due to surface defects thus lead to a lower quality product. An improvement in the foam surface reduces the frequency of the occurrence of such surface defects and thus leads to a visual improvement in the surface of such metal-polyisocyanurate-metal sandwich elements.

Furthermore, the surface flaws can likewise lead to impairment of the adhesion of the covering layers to the foam. This is likewise a big problem when, for example, these elements are used for construction of the exterior face of a building. If the adhesion of the covering layers is greatly impaired as a result of surface defects, complete detachment of the metal sheet can occur in the extreme case.

In addition, improved curing of the rigid polyisocyanurate foams compared to water-blown systems is desirable since the rigid polyisocyanurate foam then has sufficient hardness at an earlier point in time and can thus be removed from the mold more quickly. This would make a productivity increase possible, as a result of which the plants could be operated more economically. Likewise, such a foam would be able to be produced at satisfactory belt speeds in a continuous process. Here too, the productivity and thus the economics of the plant can be improved by faster curing times and thus possible higher belt speeds, so that formic acid would be available as blowing agent for the economical continuous production of sandwich elements.

It was thus an object of the present invention to improve the foam surface of rigid polyisocyanurate foams compared to the prior art and at the same time to reduce the frequency of surface defects. It was likewise an object of the present invention to provide rigid polyisocyanurate foam systems blown by means of formic acid which display good curing, modulus of elasticity, compressive strength and low brittleness and are in terms of these features comparable to known rigid polyisocyanurate foams, so that continuous production, for example by means of the double belt process, is possible.

A further object of the invention was to provide a rigid polyisocyanurate foam which gives improved results in the SBI test, especially in the measured values Figra, THR, Smogra and TSP, compared to the prior art.

The present invention further had for its object to provide a rigid foam system which meets the fire standard LPS 1181 part 1 grade B without the use of halogenated blowing agents.

It has surprisingly been found that the use of the catalyst mixture according to claim 1 in the production of rigid polyisocyanurate foams improves the foam surface of the rigid foams produced and the frequency of the occurrence of surface defects in rigid polyisocyanurate foam sandwich elements can be reduced in this way. At the same time, curing and other mechanical properties, for example the compressive strength and the modulus of elasticity, were able to be maintained at the level of rigid polyurethane foams and sometimes even improved. Likewise, it is possible to produce a rigid polyisocyanurate foam which meets the requirements of the SBI test and displays significant improvements in the measured values Figra, THR, Smogra and TSP of the SBI test compared to the rigid polyurethane foams known from the prior art.

For the purposes of the present invention, polyisocyanurates are polymeric isocyanate adducts which comprise not only urethane groups but also further groups. These further groups are formed, for example, by reaction of the isocyanate group with itself, e.g. isocyanurate groups, or by reaction of the isocyanate groups with groups other than hydroxyl groups, with the groups mentioned usually being present together with the urethane groups in the polymer. The isocyanate index of polyisocyanurates is, for the purposes of the invention, 180 and above.

For the purposes of the present invention, the isocyanate index is the stoichiometric ratio of isocyanate groups to groups which are reactive toward isocyanate, multiplied by 100. Groups which are reactive toward isocyanate are, for the inventive purposes, all groups which are comprised in the reaction mixture and are reactive toward isocyanate, including chemical blowing agents, but not the isocyanate group itself.

For the purposes of the invention, a rigid polyisocyanurate foam is a foamed polyisocyanurate, preferably a foam in accordance with DIN 7726, i.e. the foam has a compressive stress at 10% deformation or compressive strength in accordance with DIN 53 421/DIN EN ISO 604 of greater than or equal to 80 kPa, preferably greater than or equal to 150 kPa, particularly preferably greater than or equal to 180 kPa. Furthermore, the rigid polyisocyanurate foam has a proportion of closed cells in accordance with DIN ISO 4590 of greater than 85%, preferably greater than 90%.

A rigid polyisocyanurate foam according to the invention is preferably produced by a process in which
a) isocyanates are reacted with
b) compounds having groups which are reactive toward isocyanates,
c) blowing agent comprising formic acid,
d) a catalyst system and, if appropriate,
e) foam stabilizers, flame retardant and other additives, wherein an inventive catalyst system according to claim 1 is used.

With regard to the components a) to e) used, the following details may be provided.

a) As isocyanates, it is possible to use all known organic diisocyanates and polyisocyanates. Specifically, the customary aliphatic, cycloaliphatic and in particular aromatic diisocyanates and/or polyisocyanates are used. Preference is given to using tolylene diisocyanate (TDI), diphenylmethane diisocyanate (MDI) and in particular crude MDI, i.e. mixtures of diphenylmethane diisocyanate and polyphenylene-polymethylene polyisocyanates, known as polymeric MDI. The isocyanates can also be modified, for example by incorporation of uretdione, carbamate, isocyanurate, carbodiimide, allophanate and in particular urethane groups.

To produce rigid polyisocyanurate foams, particular preference is given to using crude MDI.

Furthermore, prepolymers can be used as isocyanate component. These prepolymers are prepared from the above-described isocyanates and the polyethers or polyesters described below or both and have an NCO value of from 20 to 30, preferably from 25 to 30. Isocyanurate structures can already be comprised in these prepolymers.

b) Possible compounds having groups which are reactive toward isocyanate, i.e. hydrogen atoms which are reactive toward isocyanate groups, are, in particular, compounds which bear at least 1.5, for example from 1.5 to five, preferably two or three, reactive groups selected from among OH groups, SH groups, NH groups, NH₂ groups and CH-acid groups, e.g. β-diketo groups, preferably OH groups, in the molecule. Here, the number of reactive groups in the molecule is to be regarded as a mean over the number of molecules having hydrogen atoms which are reactive toward isocyanate groups.

To produce the rigid polyisocyanurate foams which are preferably produced by the process of the invention, use is made of, in particular, compounds having from 1.5 to 8 OH groups. Preference is given to using polyetherols, polyesterols or both. These polyetherols and/or polyesterols particularly preferably have from 1.5 to 8, in particular from 2 to 4, OH groups in the molecule. The hydroxyl number of the polyetherols and/or polyesterols used in the production of rigid polyisocyanurate foams is preferably from 100 to 850 mg KOH/g, particularly preferably from 100 to 400 mg KOH/g and in particular from 150 to 300 mg KOH/g. The molecular weights are preferably greater than 400 g/mol.

Polyether polyols can be prepared by known methods, for example from one or more alkylene oxides having from 2 to 4 carbon atoms in the alkylene radical by anionic polymerization using alkali metal hydroxides such as sodium or potassium hydroxide or alkali metal alkoxides such as sodium methoxide, sodium or potassium ethoxide or potassium isopropoxide as catalysts with addition of at least one starter molecule comprising from 2 to 8, preferably from 2 to 4, reactive hydrogen atoms in bound form or by cationic polymerization using Lewis acids such as antimony pentachloride, boron fluoride etherate or bleaching earth as catalysts.

Suitable alkylene oxides are, for example, tetrahydrofuran, 1,3-propylene oxide, 1,2- or 2,3-butylene oxide, styrene oxide and preferably ethylene oxide and 1,2-propylene oxide, particularly preferably ethylene oxide. The alkylene oxides can be used individually, alternately in succession or as mixtures.

Possible starter molecules are, for example, ethylene glycol, diethylene glycol, glycerol, trimethylolpropane, pentaerythritol, sucrose, sorbitol, methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine and also other dihydric or polyhydric alcohols or monofunctional or polyfunctional amines. Preference is given to using ethylene glycol, diethylene glycol, glycerol, trimethylolpropane and toluenediamine.

The polyester alcohols used are usually prepared by condensation of polyfunctional alcohols having from 2 to 12 carbon atoms, for example ethylene glycol, diethylene glycol, butanediol, trimethylolpropane, glycerol or pentaerythritol, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, the recyclates of polyethylene terephthalate and the isomers of naphthalene dicarboxylic acids, preferably phthalic acid, isophthalic acid, terephthalic acid, the recyclates of polyethylene terephthalate and the isomers of naphthalenedicarboxylic acids or their anhydrides. Particular preference is given to polyesterols prepared from phthalic anhydride and/or terephthalic acid and/or recyclates of polyethylene terephthalate.

As further starting materials in the preparation of polyesters, it is also possible to make concomitant use of hydrophobic substances. The hydrophobic substances are water-insoluble substances which comprise a nonpolar organic radical and have at least one reactive group selected from among hydroxyl, carboxylic acid, carboxylic ester or mixtures thereof. The equivalent weight of the hydrophobic materials is in the range from 130 to 1000 g/mol. It is possible to use, for example, fatty acids such as stearic acid, oleic acid, palmitic acid, lauric acid or linoleic acid and also fats and oils such as castor oil, maize oil, sunflower oil, soybean oil, coconut oil, olive oil or tall oil. If polyesters comprise hydrophobic substances, the proportion of hydrophobic substances based on the total monomer content of the polyester alcohol is preferably from 1 to 30 mol %, particularly preferably from 4 to 15 mol %.

The polyesterols used preferably have a functionality of 1.5-5, particularly preferably 1.5-4.

In a preferred embodiment, the compounds having hydrogen atoms which are reactive toward isocyanate groups comprise at least one polyester. In a particularly preferred embodiment, the compounds having hydrogen atoms which are reactive toward isocyanate groups comprise at least one polyester comprising at least one hydrophobic substance.

It is also possible to use chain extenders and/or crosslinkers. Chain extenders and/or crosslinkers used are, in particular, bifunctional or trifunctional amines and alcohols, in particular diols, triols or both, in each case having molecular weights of less than 400, preferably from 60 to 300.

As blowing agent component c), use is made of a blowing agent comprising formic acid. This can be used as sole blowing agent or as a mixture with water and/or physical blowing agents. As physical blowing agents, preference is given to using hydrocarbons, halogenated hydrocarbons such as chlorofluorocarbons (CFCs), hydrochlorofluorocarbons (HCFCs) or hydrofluorocarbons (HFCs) and other compounds, for example perfluorinated alkanes such as perfluorohexane and also ethers, esters, ketones and acetals, or mixtures thereof. Preference is given to hydrofluorocarbons such as 1,1,1,3,3-pentafluorobutane(HFC 365mfc), 1,1,1,3,3-pentafluoropropane (HFC 245fa), 1,1,1,2-tetrafluoroethane (HFC 134a) or 1,1,1,2,3,3,3-heptafluoropropane (HFC 227ea) and mixtures thereof. Furthermore, hydrocarbons such as the isomers and derivatives of pentane can also be advantageously used as physical blowing agents.

Preference is given to using formic acid in combination with hydrofluorocarbons (HFCs) and/or hydrocarbons. In a preferred embodiment, the blowing agent component c) comprises no water apart from a water content of not more than 1.5% by weight in the formic acid. The total water content of the components b) to e) is preferably less than 0.5% by weight, particularly preferably less than 0.3% by weight, in each case based on the components b) to e). In a further preferred embodiment, formic acid is used in combination with hydrocarbons, in particular in combination with n-pentane or isomers of pentane.

The blowing agent component c) is usually used in an amount of from 1 to 30% by weight, preferably from 2 to 20% by weight and particularly preferably from 2 to 10% by weight, based on the total weight of the components b) to e).

The molar concentration of formic acid in the blowing agent component c) is preferably greater than 10 mol %, preferably greater than 20 mol %, particularly preferably greater than 35 mol %.

It is also preferred that the blowing agent component c) comprises less than 5% by weight, more preferably less than 2% by weight, particularly preferably less than 1% by weight and in particular 0% by weight, based on the total weight of the components b) to e), of chlorofluorocarbons and/or chlorinated hydrocarbons.

The catalyst system d) for producing rigid polyisocyanurate foams according to the invention comprises

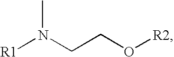

i) a compound having the structure
ii) a trimerization catalyst and, if appropriate,
iii) a further catalyst component,

with the further catalyst component iii) being an amine compound which has a maximum of 6 nitrogen atoms and is different from the catalyst components i) and ii).

As regards the components i), ii) and iii) of the catalyst system of the invention, the following may be said.

In the compound i), R¹═CH₃, CH₂CH₂N(CH₃)₂ or CH₂CH₂OH and R²═H, CH₂CH₂OH or CH₂CH₂N(CH₃)₂. In particular, this catalyst component i) is bis(dimethylaminoethyl) ether, N,N,N-trimethylaminoethylethanolamine, N,N-dimethylaminoethyl N-methyl-N-hydroxyethylaminoethyl ether, N,N-dimethylaminoethoxyethanol or dimethylethanolamine.

Compound ii) catalyzes the trimerization reaction of the NCO groups with one another. Mention may be made by way of example of metal salts, especially ammonium, alkali metal or alkaline earth metal salts of carboxylic acids. Preference is given to using the salts of linear or branched, substituted or unsubstituted, saturated or unsaturated aliphatic or aromatic carboxylic acids having from 1 to 20 carbon atoms, for example formic acid, acetic acid, octanoic acid, tartaric acid, citric acid, oleic acid, stearic acid and ricinoleic acid, or substituted or unsubstituted, aromatic carboxylic acids having from 6 to 20 carbon atoms, e.g. benzoic acid and salicylic acid. Particular preference is given to potassium formate, potassium acetate, potassium octoate, ammonium formate, ammonium acetate and ammonium octoate, in particular potassium formate.

Furthermore, compound ii) can comprise amine-comprising catalysts which likewise catalyze the trimerization reaction of the NCO groups with one another. These include, for example, 1,3,5-tris(3-dimethylaminopropyl)hexahydro-s-triazine, tris-3-dimethylaminopropylamine, pentamethyldipropylenetriamine and 2,4,6-tris(dimethylaminoethyl)phenol.

Compound (iii) comprises 1, 2, 3, 4, 5 or 6 nitrogen atoms and less than 5 oxygen atoms. Particular preference is given to using N-methyldiethanolamine, hexamethyl-triethylenetetramine, pentamethyldiethylenetriamine, bis(dimethylaminoethyl)ether, N,N,N-trimethylaminoethylethanolamine, N,N-dimethylaminoethyl N-methyl-N-hydroxyethylaminoethyl ether, N,N-dimethylaminoethoxyethanol, N,N-bis(3-dimethylaminopropyl)amino-2-propanolamine, tetramethylhexamethylenediamine, tris-3-dimethylaminopropylamine, dimethylethanolamine, triethylamine, dimethylcyclohexylamine, pentamethyldipropylenetriamine, N-methylimidazole, 1,3,5-tris(3-dimethylaminopropyl)hexahydro-s-triazine, 2,4,6-tris(dimethylaminoethyl)-phenol, N-dimethylaminopropylurea or bis-(N-dimethylaminopropyl)urea. In particular, use is made of bis(dimethylaminoethyl)ether, N,N,N-trimethylaminoethylethanolamine, N,N-dimethylaminoethoxyethanol or dimethylethanolamine.

Preference is given to using mixtures in which bis(dimethylaminoethyl)ether, N,N,N-trimethylaminoethylethanolamine or N,N-dimethylaminoethoxyethanol is present as component i) and potassium formate is present as component ii). In a further specific embodiment, the mixture further comprises a component iii) which consists of N,N,N-trimethylaminoethylethanolamine, N,N-dimethylaminoethoxyethanol or dimethylethanolamine. In a further specific embodiment, the catalyst mixture consists of i) bis(dimethylaminoethyl)ether, ii) potassium formate and iii) N,N,N-trimethylaminoethylethanolamine.

The mole fraction of the catalyst ii) in the total catalyst mixture comprising i), ii) and, if appropriate, iii) is 30-90 mol %, preferably 40-90 mol %, particularly preferably 45-85 mol %. Here, potassium formate is used as catalyst ii).

Component e) encompasses compounds which can usually be additionally used in the production of polyisocyanurates. These comprise foam stabilizers, flame retardants and other additives, for example further catalysts and antioxidants.

Foam stabilizers are substances which promote the formation of a regular cell structure during foam formation.

Examples which may be mentioned are: silicone-comprising foam stabilizers such as siloxane-oxyalkylene copolymers and other organopolysiloxanes. Also alkoxylation products of fatty alcohols, oxo alcohols, fatty amines, alkylphenols, dialkylphenols, alkylcresols, alkylresorcinol, naphthol, alkylnaphthol, naphthylamine, aniline, alkylaniline, toluidine, bisphenol A, alkylated bisphenol A, polyvinyl alcohol and also alkoxylation products of condensation products of formaldehyde and alkylphenols, formaldehyde and dialkylphenols, formaldehyde and alkylcresols, formaldehyde and alkylresorcinol, formaldehyde and aniline, formaldehyde and toluidine, formaldehyde and naphthol, formaldehyde and alkylnaphthol and also formaldehyde and bisphenol A, and mixtures of two or more of these foam stabilizers.

Foam stabilizers are preferably used in an amount of 0.5-4% by weight, particularly preferably 1-3% by weight, based on the total weight of the components b)-e).

As alkoxylation reagents, it is possible to use, for example, ethylene oxide, propylene oxide, polyTHF and higher homologues.

Flame retardants which can be used are the flame retardants in general which are known from the prior art. Suitable flame retardants are, for example, brominated ethers (Ixol B 251), brominated alcohols such as dibromoneopentyl alcohol, tribromoneopentyl alcohol and PHT-4-diol, and also chlorinated phosphates such as tris(2-chloroethyl)phosphate, tris(2-chloroisopropyl)phosphate (TCPP), tris(1,3-dichloroisopropyl)phosphate, tris(2,3-dibromopropyl)phosphate and tetrakis(2-chloroethyl)ethylenediphosphate, or mixtures thereof.

Apart from the halogen-substituted phosphates mentioned above, it is also possible to use inorganic flame retardants such as red phosphorus, preparations comprising red phosphorus, expandable graphite, aluminum oxide hydrate, antimony trioxide, arsenic oxide, ammonium polyphosphate and calcium sulfate or cyanuric acid derivatives such as melamine or mixtures of at least two flame retardants such as ammonium polyphosphates and melamine and also, if appropriate, starch for making the rigid polyisocyanurate foams produced according to the invention flame resistant.

As further liquid halogen-free flame retardants, it is possible to use diethyl ethanephosphonate (DEEP), triethyl phosphate (TEP), dimethyl propylphosphonate (DMPP), diphenyl cresyl phosphate (DPC) and others.

Preference is given to using tris(2-chloroisopropyl)phosphate (TCPP), diethyl ethanephosphonate (DEEP), diphenyl cresyl phosphate (DPC) or expandable graphite. In a particularly preferred embodiment, only halogen-free flame retardants are used.

The flame retardants are, for the purposes of the present invention, preferably used in an amount of from 0 to 60% by weight, particularly preferably from 5 to 50% by weight, more preferably from 10 to 30% by weight, in particular from 5 to 40% by weight, based on the total weight of the components b) to e).

In addition, the customary fillers can be used.

To produce the rigid polyisocyanurate foams, the polyisocyanates a) and the components b) to e) are reacted in such amounts that the isocyanate index is from 180 to 700, preferably from 250 to 500, in particular from 300 to 400.

The rigid polyisocyanurate foams can be produced batchwise or continuously with the aid of known processes (e.g. double belt). The invention described here relates to both processes, but preferably to the continuous double belt process. In this process, an upper covering layer and a bottom covering layer, for example layers of metal, aluminum foil or paper, are rolled off a roll and, if appropriate, profiled, heated and corona-treated in order to improve the ability to apply foam to the covering layers. The reaction mixture comprising the components a) to d) and, if appropriate, e) is then mixed, for example in a high-pressure mixing head, applied to the bottom covering layer and cured between the upper and lower covering layer in what is known as the double belt. The elements are subsequently cut to the desired length. If appropriate, a primer is additionally applied to the bottom covering layer before application of the rigid polyisocyanurate foam system.

It has been found to be particularly advantageous to employ the two-component process. For this purpose, the compounds having at least two groups which are reactive toward isocyanates, chemical blowing agents, catalysts and, if appropriate, foam stabilizers, flame retardants and other additives form the polyol component, while the isocyanates used for the reaction form the isocyanate component. Physical blowing agents can be comprised both in the polyol component and the isocyanate component. In the production of the actual rigid polyisocyanurate foam, polyol component and isocyanate component are then reacted with one another.

The blowing agent component c), in particular formic acid, can be added to the polyol component during the production of the rigid polyisocyanurate foam or before the start of the production of the rigid polyisocyanurate foam. For instance, the blowing agent component c), in particular formic acid, can be metered separately into the polyol component by the low pressure technique during the production process of the rigid polyisocyanurate foam or alternatively be added directly at the mixing head by the high pressure technique.

Particular advantages of the catalyst system of the invention are that particularly few surface defects are obtained when using the catalyst system of the invention for producing rigid polyisocyanurate foams. The frequency of surface defects is measured by an optical method. In this method, a plane parallel to the lower covering layer is placed in a foam specimen at a distance of a few millimeters from the bottom covering layer, i.e. the covering layer onto which the polyurethane reaction mixture has been applied, for example in the double belt process, and material above this is separated off. The foam surface obtained in this way is illuminated at an opening angle of 5° and the area of the shadows cast by surface defects is divided by the total area of the section. The proportion of the area covered by shadows, based on the total area, is preferably less than 15%, more preferably less than 10% and in particular less than 5%.

The rigid polyisocyanurate foams of the invention have a good compressive strength and a low brittleness. The compressive strength, measured perpendicular to the foaming direction in accordance with DIN 53421, is preferably greater than 0.08 N/mm², particularly preferably greater than 0.12 N/mm² and in particular greater than 0.15 N/mm².

Furthermore, rigid polyisocyanurate foams according to the invention have a low needle height. The needle height is determined on a foam produced in a polystyrene cup from 80 g of mix. It indicates the height through which the foam continues to rise between the fiber time and complete curing. Excessive further expansion of the foam after the fiber time has been reached is undesirable, since it has an adverse effect on the mechanical properties of the foam, for example modulus of elasticity and compressive strength. The needle height of a rigid polyisocyanurate foam according to the invention is preferably less than 40 mm, particularly preferably less than 35 mm and in particular less than 30 mm.

Furthermore, the rigid polyisocyanurate foams of the invention are good thermal insulation materials for refrigeration appliances, containers and buildings. The present invention therefore includes refrigeration appliances, containers and buildings which comprise the rigid polyisocyanurate foams of the invention as insulation materials.

Further advantages of the invention are that very good curing of the rigid polyisocyanurate foam is achieved by means of the catalyst system of the invention. The curing can be determined by means of the indentation test. In this test, 3, 4, 5, 6, 8 and 10 minutes after mixing of the components in a polystyrene cup, a steel indenter having a hemispherical end having a radius of 10 mm is pressed to a depth of 10 mm into the foam formed by means of a tensile/compressive testing machine. The maximum force in N which is required for this is a measure of the curing of the foam. After 3 minutes, this is preferably greater than 60 newton, particularly preferably greater than 65 newton and in particular greater than 70 newton, and after 10 minutes is preferably greater than 130 newton, particularly preferably greater than 140 newton and in particular greater than 150 newton. The total of the force for the tests after 3, 4, 5, 6, 8 and 10 minutes is preferably greater than 500 newton, particularly preferably greater than 550 newton and in particular greater than 600 newton. A rigid polyisocyanurate foam according to the invention is thus highly suitable for carrying out the double belt process for producing metal-rigid polyisocyanurate foam-metal sandwich elements.

Furthermore, the rigid polyisocyanurate foams have a particularly low thermal conductivity which makes them excellent insulation materials, for example in the building sector. The thermal conductivity is measured in accordance with DIN 52612 and is less than 30 mW/mK, preferably less than 28 mW/mK and particularly preferably less than 26 mW/mK, measured directly after production of the rigid polyisocyanurate foams.

A rigid foam according to the invention also has particularly good burning properties, measured, for example, in the SBI test. When 80 mm thick insulation boards having aluminum covering layers having a thickness of 50 μm are used in this test, the following measured values are preferably achieved: Figra<250 W/s, particularly preferably <200 W/s, THR<5.5 MJ, particularly preferably <5.2 MJ, Smogra<100 m²/s², particularly preferably <90 m²/s², and TSP<110 m², particularly preferably <100 m².

The present invention is illustrated by the following examples:

Measurement Methods:

Curing

Curing was determined by means of the indentation test. For this purpose, 3, 4, 5, 6, 8 and 10 minutes after mixing of the components in a polystyrene cup, a steel indenter having a hemispherical end having a radius of 10 mm is pressed to a depth of 10 mm into the foam formed by means of a tensile/compressive testing machine. The maximum force in N which is required for this is a measure of the curing of the foam. As a measure of the brittleness of the rigid polyisocyanurate foam, the point in time at which the surface of the rigid foam had visible fracture zones in the indentation test was determined.

Surface Defects

The test specimens for assessment of the frequency of surface defects were produced by the double belt process.

The surface defects were determined by the above-described method. For this purpose, a 20 cm×30 cm foam specimen is pretreated as described above and illuminated and subsequently photographed. The photographs of the foam were subsequently binarized and superimposed. The integrated area of the black regions of the binary images was divided by the total area of the images and is thus a measure of the frequency of surface defects.

Furthermore, an additional qualitative assessment of the nature of the surface of the rigid polyisocyanurate foams was carried out, in which the covering layer was removed from a 1 m×2 m foam specimen and the surface was assessed visually for surface defects.

Compressive Strength

The compressive strengths and compressive moduli of elasticity of the rigid polyisocyanurate foams were measured in accordance with DIN 53421/DIN EN ISO 604 perpendicular to the covering layer on sandwich elements produced by the double belt process at an overall foam density of 40 g/l.

Needle Height

The needle height is determined on a foam having a diameter of 10.4 cm produced in a polystyrene cup using 80 g of mix. It indicates the height through which the foam continues to rise between the fiber time and the achievement of complete curing. Excessive further expansion of the foam after the fiber time is undesirable.

Flame Resistance

The flame height was measured in accordance with EN ISO 11925-2.

The SBI test is carried out in accordance with EN 13823. Here, sandwich elements having aluminum covering layers which had been produced by the double belt process and which had a foam thickness of 80 mm and a thickness of the aluminum covering layers of 50 μm each were used. In the SBI test, the evolution of heat [W/s] on application of a flame by means of a standardized burner is measured. The parameters determined are the fire growth rate (Figra), the total heat release (THR), the smoke growth rate (Smogra) and the total smoke production (TSP). The Figra is the quotient of the maximum energy release and the time until this maximum is reached. The THR is the total energy release in the first 10 minutes after application of the flame is commenced. The Smogra is the quotient of the maximum of the smoke evolution and the time until the maximum is reached. The TSP is the total smoke evolution in the first 10 minutes after application of the flame is commenced.

The performance of the Test Loss Prevention Standard LPS 1181 part 1 grade B is stipulated in the corresponding standard issued by the Loss Prevention Certification Board (LPCB) on Sep. 16, 2005. In this test, a garage is built up from sandwich elements and subjected to a very demanding fire scenario. Fire propagation is the decisive criterion for judging test performance.

### Production of a Rigid Polyisocyanurate Foam

The isocyanates and the components which are reactive toward isocyanate were foamed together with the blowing agents, catalysts and all further additives at an index of 350. A constant fiber time of 45 seconds and an overall foam density of 45 g/l were set in each case. In the case of sandwich elements produced by the double belt process, the foam density was 40 g/l.

### EXAMPLES ACCORDING TO THE INVENTION

### Example 1

Polyol Component

58 parts by weight of polyesterol consisting of the esterification product of phthalic anhydride, diethylene glycol and oleic acid and having a hydroxyl functionality of 1.8 and a hydroxyl number of 200 mg KOH/g

10 parts by weight of polyetherol consisting of the ether of ethylene glycol and ethylene oxide and having a hydroxyl functionality of 2 and a hydroxyl number of 200 mg KOH/g

30 parts by weight of flame retardant trischloroisopropyl phosphate (TCPP)

2 parts by weight of stabilizer; Tegostab B 8443 (silicone-comprising stabilizer)

6 parts by weight of n-pentane

2.1 parts by weight of formic acid (99%)

1.5 parts by weight of potassium formate (36% by weight in ethyleneglycol)

1.4 parts by weight of N,N,N-trimethylaminoethylethanolamine (Dabco T)

Isocyanate Component

190 parts by weight of Lupranat M50 (polymeric MDI)

The components A and B were foamed with one another as indicated above. The results of the indentation test, the brittleness, the compressive strength, the compressive modulus of elasticity, the needle height, the SBI test and the qualitative assessment of the nature of the surface are reported in table 1.

### Example 2

The procedure of example 1 was repeated using 1.4 parts by weight of bis(2-dimethylaminoethyl)ether (Niax A1; 70% in dipropylene glycol) in place of the 1.4 parts by weight of N,N,N-trimethylaminoethylethanolamine (Dabco T). The results of the indentation test, the brittleness and the needle height are reported in table 2.

### Example 3

The procedure of example 1 was repeated using a mixture of 0.6 part by weight of N,N,N-trimethylaminoethylethanolamine (Dabco T) and 0.6 part by weight of bis(2-dimethylaminoethyl)ether (Niax A1; 70% in dipropylene glycol) in place of the 1.4 parts by weight of N,N,N-trimethylaminoethylethanolamine (Dabco T). The results of the indentation test, the brittleness and the needle height are reported in table 2.

### Example 4

The procedure of example 1 was repeated using a mixture of 0.6 part by weight of N,N,N-trimethylaminoethylethanolamine (Dabco T) and 0.6 part by weight of dimethylethanolamine (Lupragen N 101) in place of the 1.4 parts by weight of N,N,N-trimethylaminoethylethanolamine (Dabco T). The results of the indentation test, the brittleness and the needle height are reported in table 2.

### Example 5

The procedure of example 1 was repeated except that the 58 parts by weight of a polyesterol based on phthalic anhydride were replaced by 58 parts by weight of a polyesterol based on terephthalic acid, diethylglycol, trimethylolpropane and oleic acid having a functionality of 2.2 and an OH number of 230. The results of the indentation test, brittleness, compressive strength, compressive modulus of elasticity, needle height, the SBI test and the qualitative assessment of the nature of the surface are reported in table 1. This reaction mixture was also used to produce sandwich elements with integral joint. These sandwich elements had a thickness of 120 mm and were faced on either side by steel sheets 0.6 mm in thickness. The density of the foam was 45 g/L. Such wall elements were subjected to the loss prevention standard LPS 1181 part 1 grade B test; the results are reported in table 1.

### Comparative Example 1

Polyol Component

58 parts by weight of polyesterol consisting of the esterification product of phthalic anhydride, diethylene glycol and oleic acid and having a hydroxyl functionality of 1.8 and a hydroxyl number of 200 mg KOH/g

10 parts by weight of polyetherol consisting of the ether of ethylene glycol and ethylene oxide and having a hydroxyl functionality of 2 and a hydroxyl number of 200 mg KOH/g

30 parts by weight of flame retardant trischloroisopropyl phosphate (TCPP)

2 parts by weight of stabilizer; Tegostab B 8443 (silicone-comprising stabilizer)

13 parts by weight of n-pentane

0.8 part by weight of water/dipropylene glycol mixture (60:40)

1.5 parts by weight of potassium formate (36% by weight in ethylene glycol)

1.4 parts by weight of bis(2-dimethylaminoethyl)ether (Niax A1; 70% by weight in dipropylene glycol)

Isocyanate Component

190 parts by weight of Lupranat M50

The components A and B were foamed with one another as indicated above. The results of the indentation test, the brittleness, the compressive strength, the compressive modulus of elasticity, the needle height, the SBI test and the qualitative assessment of the nature of the surface are reported in table 1. This reaction mixture was also used to produce sandwich elements with integral joint. These sandwich elements had a thickness of 120 mm and were faced on either side by steel sheets 0.6 mm in thickness. The density of the foam was 45 g/L. Such wall elements were subjected to the loss prevention standard LPS 1181 part 1 grade B test; the results are reported in table 1.

### Comparative Example 2

The procedure of comparative example 1 was repeated using 6 parts by weight of n-pentane and 2.1 parts by weight of a 99% strength by weight formic acid as blowing agent in place of 13 parts by weight of n-pentane. Furthermore, 1.6 parts by weight of dimethylcyclohexylamine were used in place of 1,4 parts by weight of bis(2-dimethylaminoethyl)ether (Niax A1; 70% by weight in dipropylene glycol). The results of the indentation test, the brittleness and the needle height are reported in table 2.

### Comparative Example 3

The procedure of comparative example 1 was repeated using 6 parts by weight of n-pentane and 2.1 parts by weight of a 99% strength by weight formic acid as blowing agent in place of 13 parts by weight of n-pentane. Furthermore, 1.6 parts by weight of triethylamine were used in place of 1.4 parts by weight of bis(2-dimethylaminoethyl)ether (Niax A1; 70% by weight in dipropylene glycol). The results of the indentation test, the brittleness and the needle height are reported in table 2.

TABLE 1

| | Example 1 | Example 5 | Comp. ex. 1 |
|---|---|---|---|
| Indentation test after 3 min [N] | 70 | 70 | 72 |
| Indentation test after 10 min [N] | 145 | 140 | 130 |
| Brittleness; fracture of the surface after x | — | — | 6 |
| minutes | | | |
| Compressive modulus of elasticity [N/mm²] | 4.25 | 4.1 | 3.85 |
| Compressive strength [N/mm²] | 0.15 | 0.16 | 0.15 |
| Needle height [mm] | 29 | 31 | 35 |
| Flame height in accordance with EN ISO 11925-2 | 6 | 5 | 11 |
| [cm] | | | |
| Figra in accordance with EN 13823 [W/s] | 222 | 210 | 267 |
| THR in accordance with EN 13823 [MJ] | 5.3 | 5.1 | 5.7 |
| Smogra in accordance with EN 13823 [m²/s²] | 83 | 86 | 105 |
| TSP in accordance with EN 13823 [m²] | 101 | 110 | 114 |
| Base flaws [%]/visual assessment | 3.8/good | 4.2/good | 16.8/poor |
| LPS 1181, part 1, grade B | — | pass | fail |

Table 1 shows that the use of a catalyst system according to the invention for producing rigid polyisocyanurate foam accelerates curing, reduces brittleness, increases the elasticity, improves the burning behavior in accordance with EN 13823 and enables the frequency of surface defects to be reduced at a constant compressive strength.

TABLE 2

| | | | | | Comp.- | Comp. |
|---|---|---|---|---|---|---|
| | Ex. 1 | Ex. 2 | Ex. 3 | Ex. 4 | ex. 2 | ex. 3 |
| Indentation test after | 70 | 68 | 65 | 74 | 61 | 52 |
| 3 min [N] | | | | | | |
| Indentation test after | 145 | 159 | 158 | 152 | 135 | 126 |
| 10 min [N] | | | | | | |
| Brittleness; fracture of | — | — | — | — | 6 | 6 |
| the surface after x | | | | | | |
| minutes | | | | | | |
| Needle height [mm] | 29 | 30 | 32 | 31 | 33 | 35 |

Table 2 shows that the rigid polyisocyanurate foams produced by the process of the invention display improved curing behavior, lower brittleness and a reduced needle height.

1. A process for producing rigid polyisocyanurate foams by reacting
a) isocyanates with
b) compounds having groups which are reactive toward isocyanates,
c) blowing agent comprising formic acid,
d) a catalyst system and
e) optionally foam stabilizers, flame retardant and other additives,
wherein the catalyst system comprises
(i) at least one compound having the structure: 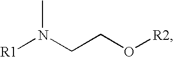
where R¹ is CH₃, CH₂—CH₂—N(CH₃)₂ or CH₂—CH₂OH and
R² is H, CH₂—CH₂OH or CH₂—CH₂N(CH₃)₂,
and
at least one trimerization catalyst (ii) selected from among the group consisting of ammonium, alkali metal and alkaline earth metal salts of carboxylic acids.

2. The process according to claim 1, wherein the trimerization catalyst ii) is selected from the group consisting of potassium formate, potassium acetate, potassium octanoate, ammonium formate, ammonium acetate, ammonium octanoate and mixtures thereof.

3. The process according to claim 1, wherein the trimerization catalyst ii) is potassium formate.

4. The process according to claim 1, wherein the catalyst system comprises a further catalyst component iii) which is an amine compound which has a maximum of 6 nitrogen atoms and is different from the catalyst components i) and ii).

5. The process according to claim 1, wherein the rigid polyisocyanurate foam is produced continuously.

6. The process according to claim 5, wherein the rigid polyisocyanurate foam is produced by a double belt process.

7. The process according to claim 1, wherein the blowing agent comprises more than 20 mol %.

8. The process according to claim 1, wherein the blowing agent comprises formic acid and physical blowing agents.

9. The process according to claim 8, wherein the physical blowing agent consists of hydrofluorocarbons.

10. The process according to claim 8, wherein the physical blowing agent consists of hydrocarbons.

11. The process according to claim 1, wherein the components b) to e) comprise less than 0.5% by weight, of water.

12. The process according to claim 6, wherein the compounds which are reactive toward isocyanates comprise at least one polyester polyol whose monomer components comprise from 1 to 20 mol % of a hydrophobic substance.

13. The process according to claim 1, wherein, to produce the rigid polyisocyanurate foams, the polyisocyanate and the components b) to e) are reacted in such amounts that the isocyanate index is from 180 to 700.

14. (canceled)
